(19) United States
(12) Patent Application Publication
(10) Pub. No.: US 2021/0079496 A1
(43) Pub. Date: Mar. 18, 2021

(54) METHOD FOR THE RECOVERY OF LITHIUM

(71) Applicants: NMR 360 Inc, Ville St. Laurent (CA); Urban Mining Pty Ltd, West Perth (AU)

(72) Inventors: Bryn Harris, Alexandria (CA); Carl White, Ville-Saint-Laurent (CA)

(21) Appl. No.: 16/620,184

(22) PCT Filed: Jun. 8, 2018
(86) PCT No.: PCT/AU2018/050567

§ 371 Date: Dec. 6, 2019

Related U.S. Application Data
(60) Provisional application No. 62/516,812, filed on Jun. 8, 2017.

(51) Int. Cl. C22B 26/12; C22B 3/42

(52) U.S. Cl. CPC C22B 26/12; H01M 10/0525; C22B 3/42

(57) ABSTRACT

A method is disclosed for maximising the recovery of lithium from purified feed solutions in either chloride or sulphate media. The solubility of lithium carbonate is sufficiently high that conventional techniques do not recover all of the lithium. An ion exchange process has been developed wherein the residual lithium is also recovered, leading to essentially 100% recovery of the lithium in the process solution.

### FIELD OF THE INVENTION

The present invention relates to methods for the recovery of lithium from various feed materials.

### BACKGROUND OF THE INVENTION

The use of rechargeable Li-ion batteries has been growing steadily, and this growth will increase considerably as electric cars become more reliable and available, coupled with the increasing demand for off-peak mass electric power storage. It is variously estimated that there will be a shortfall of lithium, in particular, by the year 2023.

Recovery of lithium from the abundant brines in South America, whilst relatively straightforward, cannot supply sufficient lithium without creating a massive amount of chlorine, for which there is no discernible market. On the other hand, lithium recovery from hard rocks, such as spodumene, incurs very high mining costs. Thus, there is also a requirement for the recycling of batteries to generate additional lithium.

Irrespective of the source of the lithium, ultimately recovery from either a sulphate or a chloride-based solution as lithium hydroxide or lithium carbonate, which are the precursors for lithium ion batteries, is required. Lithium compounds are generally not quite as soluble as those of the other alkali metals, such as sodium and potassium, especially lithium carbonate, which therefore allows for its recovery by precipitation reactions.

Nevertheless, lithium carbonate still has a relatively high residual solubility of 13.3 g/L at 20° C., lithium bicarbonate being 57.4 g/L and lithium hydroxide 128 g/L. Thus, the precipitation reaction, no matter how it is carried out, will still leave a substantial amount of lithium remaining in solution which is not recovered.

Guy Bourassa et al., in U.S. Pat. No. 9,382,126 B1, entitled “Process for Preparing Lithium Carbonate”, published on Jul. 5, 2016, describe a method wherein lithium is extracted into a sulphate solution. The solution undergoes various precipitation and ion exchange purification steps familiar to those skilled in the art to generate a pure lithium sulphate solution, which then undergoes electrolysis, to produce a lithium hydroxide solution/slurry. This slurry is then treated with pressurised carbon dioxide to generate pure lithium carbonate. The intent of the pressurised carbon dioxide is both to minimise the level of sodium, as would be the case with sodium carbonate, and also to reduce this residual solubility, but such a method can never entirely ensure 100% precipitation.

Yatendra Sharma, in PCT publication WO 2016/119003 A1, entitled “Processing of Lithium Containing Material Including HCl Sparge”, published on Aug. 4, 2016, describes a very similar process, but in a chloride medium. Again, lithium is extracted into a solution which undergoes various precipitation and ion exchange purification steps familiar to those skilled in the art, including salting out of potassium and sodium via sparging with HCl gas, to generate a pure lithium chloride solution. This then undergoes electrolysis to produce a lithium hydroxide solution/slurry, which is treated with pressurised carbon dioxide to generate pure lithium carbonate. The same comments as for the above process apply to this.

Additionally, electrolysis, whether carried out in sulphate or chloride, is an expensive operation, and requires the capture of various gases such as chlorine or oxygen mist from the cell. Carbonation, using pressurised carbon dioxide is an inefficient operation, and is also expensive, requiring as it does that carbon dioxide be pressurised in order to be used, but still leaves some lithium unrecovered.

George M. Burkert and Reuben B. Ellestad, in U.S. Pat. No. 3,523,751 entitled “Precipitation of Lithium Carbonate from Lithium Chloride Solution”, and issued on Aug. 11, 1970, describe a method for the precipitation of lithium carbonate with soda ash (sodium carbonate).

In view of the above, it is desirable to provide a process for improving the recovery of lithium while avoiding one or more of the problems of prior art processes.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In one aspect of the invention, there is provided a method for recovery of lithium, the method including:

contacting a lithium-containing aqueous solution with a phosphonic-sulfonic acid resin to adsorb lithium to a surface of the phosphonic-sulfonic acid resin to form a Li-loaded resin and a Li-barren solution; and

eluting lithium from the Li-loaded resin with an eluant to form a Li-rich eluant solution.

The inventors have found that the phosphonic-sulfonic acid resin can be used to adsorb substantially all of the lithium in the lithium-containing aqueous solution. By substantially all it is meant that at least 97 wt % of the lithium is adsorbed; preferably at least 98 wt %; more preferably at least 99 wt %; and most preferably more than 99 wt %.

In an embodiment, the eluant is selected from the group consisting of: a bicarbonate solution, a hydrochloric acid solution, or a sulphuric acid solution.

In an embodiment, the eluant is a bicarbonate solution having a bicarbonate ion concentration that is less than solubility limit for LiHCO₃. Preferably, the bicarbonate solution is a sodium and/or potassium bicarbonate solution.

In an embodiment, the eluant is selected from the group consisting of: a hydrochloric acid solution containing at least 5 wt % hydrochloric acid, and/or a sulphuric acid solution containing at least 5 wt % sulphuric acid.

In an embodiment, the lithium-containing aqueous solution is substantially free of ions of copper, iron, aluminium, nickel, cobalt and/or manganese. By substantially free it is meant that the Li-containing aqueous solution includes less than 1 wt % of each of copper, iron, aluminium, nickel, cobalt or manganese; preferably less than 0.5 wt % of each of copper, iron, aluminium, nickel, cobalt or manganese; more preferably less than 0.1 wt % of each of copper, iron, aluminium, nickel, cobalt or manganese. Preferably, the Li⁺ containing solution is substantially free of any transition metal ions. By substantially free it is meant that the Li-containing aqueous solution includes less than 1 wt % of any transition metals; preferably less than 0.5 wt % of transition metals; more preferably less than 0.1 wt % of transition metals.

In an embodiment, the lithium-containing aqueous solution includes a total amount of lithium that is less than or equal to the saturation concentration of Li in the lithium-containing solution.

In an embodiment, prior to the contacting step, the method includes:

a precipitation step including treating an initial lithium containing aqueous solution with a precipitant to form a Li-containing precipitate; and

separating the Li-containing precipitate to form the lithium containing aqueous solution.

In one form of this embodiment, the method further includes recycling the Li-rich eluant solution into the initial lithium-containing aqueous solution in the precipitation step. Advantageously, this provides a method for maximising the recovery of lithium.

In an embodiment, the Li-containing precipitate is substantially free of other metals. By substantially free of other metals it is meant that the Li-containing precipitate includes less than 1 wt % of non-Li metals; preferably less than 0.5 wt % of non-Li metals; more preferably less than 0.1 wt % of non-Li metals.

In one form of this embodiment, the precipitant is selected to form a precipitate of Li₂CO₃.

In one form of this embodiment, the precipitant is a carbonate or bicarbonate. In cases where the precipitant is bicarbonate, the method preferably includes boiling the Li-containing leachate to form a Li₂CO₃ precipitate.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1: A process flow diagram illustrating an embodiment of the invention.

### DETAILED DESCRIPTION OF THE EMBODIMENTS

The description, and the embodiments described therein, is provided by way of illustration of examples of particular embodiments of principles and aspects of the present invention. These examples are provided for the purposes of explanation and not of limitation, of those principles of the invention. In the description that follows, like parts and/or steps are marked throughout the specification and the drawing with the same respective reference numerals.

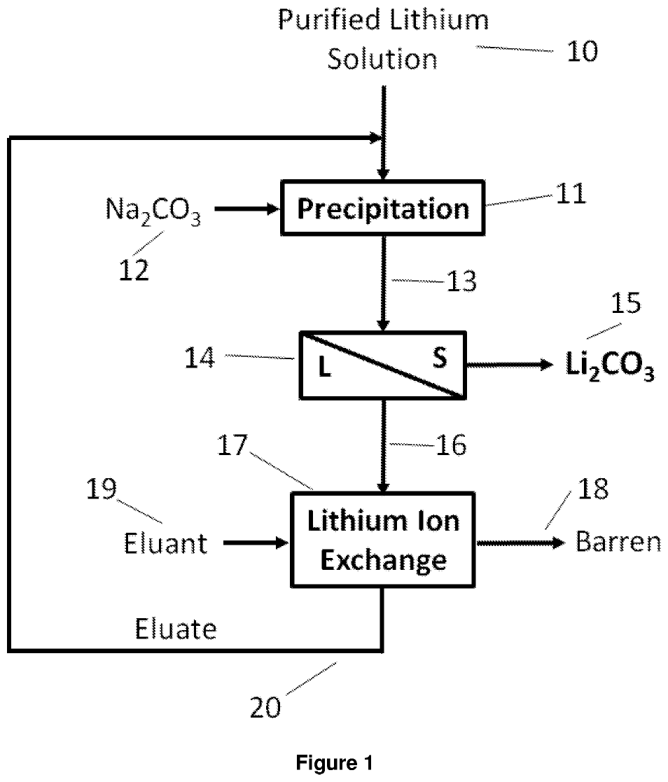

The embodiments of the present invention shall be more clearly understood with reference to the following description and FIG. 1.

FIG. 1 provides a schematic representation of a method for the recovery of lithium from process solutions or brines and maximising that recovery. The process solutions may be in chloride or in sulphate form, and may be derived from a salt brine or from the leaching of a lithium mineral such as, but not limited to, spodumene.

In the embodiment of FIG. 1, a lithium process solution is initially treated in a purification process (not shown) to remove metal ions that may interfere with the recovery of lithium to form a purified lithium solution 10. These metal ions include at least copper, iron, aluminium, nickel, or manganese.

The purified lithium solution 10 is then reacted with a precipitant 12 to precipitate lithium in the form of lithium carbonate 15 to form a precipitation slurry 13. The precipitant 12 may be sodium or potassium carbonate or bicarbonate. However, in this embodiment, sodium carbonate is used.

The precipitation slurry 13 then undergoes solid-liquid separation 14 resulting in a solids stream including the lithium carbonate precipitate 15 and a liquid filtrate 16 which is substantially saturated with lithium carbonate. The solid-liquid separation 14 may be effected by any convenient means, such as, but not limited to, flocculation and thickening, filter press or vacuum belt filter.

The solids stream including the lithium carbonate precipitate 15 is washed.

As noted in the background, lithium carbonate has a relatively high residual solubility of 13.3 g/L at 20° C. This means that a substantial portion of the lithium is not recovered by the precipitation reaction, and that the filtrate 16 from lithium carbonate precipitation 14 still contains appreciable lithium.

In order to recover this lithium, which would otherwise be lost, the inventors have found that a combined phosphonic-sulfonic acid resin (such as the Purolite ion exchange resin S957) will quantitatively load lithium from such solutions, affecting a very high recovery of lithium, and can for example allow for essentially all of the lithium to be recovered. This resin was developed, and is used, for the removal of small quantities of iron from copper electrowinning solutions, such that its use for lithium recovery is entirely novel and unexpected.

The filtrate 16 is passed through a series of ion exchange columns 17, in which the lithium is loaded onto the resin to form a Li-loaded resin and a Li-barren solution 18. The Li-barren solution 18 predominantly includes sodium or potassium sulphate or chloride, and may be disposed of, or further treated.

The loaded resin is eluted with an eluant 19, which is preferably sodium or potassium bicarbonate to form a lithium bicarbonate eluate solution 20. Care has to be taken not to exceed the solubility limit of the bicarbonate, which is 57.4 g/L at 20° C., some four times higher than for lithium carbonate. Alternatively, strong hydrochloric or sulphuric acid be used, but the bicarbonate is preferred.

The lithium bicarbonate eluate solution 20 is recycled to the lithium carbonate precipitation stage 11 for recovery of the lithium. In this way, no lithium is lost from the circuit, and the maximum amount of lithium is recovered.

The principles of the present invention are illustrated by the following examples, which are provided by way of illustration, but should not be taken as limiting the scope of the invention.

### EXAMPLE 1

A lithium sulphate/sodium sulphate solution, derived from the leaching of spent lithium-ion batteries, and from which all of the copper, iron, aluminium, nickel, cobalt and manganese had been removed, and analysing 3.41 g/L Li (which is the residual solubility of lithium carbonate), was passed downflow through a 50-mL bed of Purolite ion exchange resin S957 contained in a 1-cm diameter column at a flowrate of 2 BV/hour. The resin was in its hydrogen, rather than the more favoured sodium, form. Breakthrough occurred after the second bed volume, and full loading was achieved after the passage of three bed volumes, indicating that a lead-lag-lag-lag type of configuration would ensure 100% recovery of the lithium. Full loading was calculated to be 0.3 equivalents of Li per litre of wet settled resin, which is quite high for this type of resin, especially in its hydrogen form as used here, and is the same as reported by the manufacturer for the loading of iron, its originally-intended purpose.

This example demonstrates the ability the ion exchange process to maximise the recovery of lithium from process solutions.

It will be understood that the invention disclosed and defined in this specification extends to all alternative combinations of two or more of the individual features mentioned or evident from the text or drawings. All of these different combinations constitute various alternative aspects of the invention.

1. A method for recovery of lithium, the method including:
contacting a lithium-containing aqueous solution with a phosphonic-sulfonic acid resin to adsorb the lithium to a surface of the phosphonic-sulfonic acid resin to form an Li-loaded resin and a Li-barren solution; and
eluting lithium from the Li-loaded resin with an eluant to form a Li-rich eluant solution.

2. The method of claim 1, wherein the eluant is selected from the group consisting of: a bicarbonate solution, a hydrochloric acid solution, or a sulphuric acid solution.

3. The method of claim 1, wherein the eluant is a bicarbonate solution having a bicarbonate ion concentration that is less than solubility limit for LiHCO₃.

4. The method of claim 3, wherein the bicarbonate solution is a sodium and/or potassium bicarbonate solution.

5. The method of claim 1, wherein the eluant is selected from the group consisting of: a hydrochloric acid solution containing at least 5 wt % hydrochloric acid, and/or a sulphuric acid solution containing at least 5 wt % sulphuric acid.

6. The method of claim 1, wherein the lithium containing aqueous solution is substantially free of copper, iron, aluminium, nickel, cobalt and/or manganese.

7. The method of claim 1, wherein the lithium containing aqueous solution includes a total amount of lithium that is less than or equal to the saturation concentration of Li in the lithium containing solution.

8. The method of claim 1, wherein prior to the contacting step, the method includes:
a precipitation step including treating an initial lithium containing aqueous solution with a precipitant to form a Li-containing precipitate; and
separating the Li-containing precipitate to form the lithium containing aqueous solution.

9. The method of claim 8, further including recycling the Li-rich eluant solution into the initial lithium containing aqueous solution in the precipitation step.

10. The method of claim 8, wherein the precipitant is selected to form a precipitate of Li₂CO₃.

11. The method of claim 1, wherein the phosphonic-sulfonic acid resin adsorbs at least 97 wt % of the lithium in the lithium containing aqueous solution.

12. The method of claim 11, wherein the phosphonic-sulfonic acid resin adsorbs more than 99 wt % of the lithium in the lithium containing aqueous solution.
